(19) United States
(12) Patent Application Publication
(10) Pub. No.: US 2024/0187939 A1
(43) Pub. Date: Jun. 6, 2024

(54) LOAD BALANCING USING DYNAMIC DUAL ACTIVE PROTOCOL STACKS

(71) Applicant: InterDigital Patent Holdings, Inc., Wilmington, DE (US)

(72) Inventors: Oumer Teyeb, Montreal (CA); Martino M. Freda, Laval (CA); Yugeswar Deenoo Narayanan Thangaraj, Chalfont, PA (US)

(73) Assignee: InterDigital Patent Holdings, Inc., Wilmington, DE (US)

(21) Appl. No.: 18/284,996

(22) PCT Filed: Mar. 30, 2022
(86) PCT No.: PCT/US2022/022522

§ 371 Date: Sep. 29, 2023

Related U.S. Application Data
(60) Provisional application No. 63/167,921, filed on Mar. 30, 2021.

(51) Int. Cl. H04W 36/00; H04W 28/082

(52) U.S. Cl. CPC H04W 36/0069; H04W 28/082

(57) ABSTRACT

Systems, methods, and instrumentalities are described herein associated with dual active protocol stack (DAPS) operations (e.g., dual communication operations). DAPS operations may be performed to enable temporary load-balancing. Performing a handover (e.g., DAPS handover) may be expensive (e.g., in terms of resources) and less desirable for load-balancing purposes. Temporary DAPS operations may be performed to achieve temporary load-balancing without performing a handover. A wireless transmit/receive unit (WTRU) in communication with a first network entity may be configured to initiate dual communication operations (e.g., DAPS) towards a second network entity. The WTRU may maintain the dual communication between the first and second network entities, for example, until an indication to release the dual communication is received or until conditions are satisfied. Releasing the dual communication may prevent expensive handovers that may use excess resources.

### CROSS-REFERENCE TO RELATED APPLICATIONS

The application claims the benefit of U.S. Provisional Application 63/167,921, filed Mar. 30, 2021, the contents of which are incorporated by reference in their entirety herein.

### BACKGROUND

A communication system such as an LTE or 5G/NR communication system may be configured to perform dual active protocol stack (DAPS) handovers, for example, to reduce the interruption time during handover. Such interruption time may, for example, range from 30 ms to 60 ms, depending on the handover scenario. So DAPS may ensure that the quality of highly delay-sensitive services not be degraded because of mobility.

### SUMMARY

Systems, methods, and instrumentalities are described herein associated with dual active protocol stack (DAPS) operations (e.g., dual communication operations). DAPS operations may be performed to enable temporary load-balancing. Performing a handover (e.g., DAPS handover) may be expensive (e.g., in terms of resources) and less desirable for load-balancing purposes. Temporary DAPS operations may be performed to achieve temporary load-balancing without performing a handover. A wireless transmit/receive unit (WTRU) in communication with a first network entity may be configured to initiate dual communication operations (e.g., DAPS) towards a second network entity. The WTRU may maintain the dual communication between the first and second network entities, for example, until an indication to release the dual communication is received or until conditions are satisfied. Releasing the dual communication may prevent expensive handovers that may use excess resources.

To perform temporary-load balancing, a WTRU may be configured to perform the following. The WTRU may be configured to receive configuration information. The configuration information may include information associated with performance of a dual communication operation (e.g., DAPS). The WTRU may be configured to perform the dual communication operation based on the configuration information. The dual communication operation may include communicating with a first network entity (e.g., source node, source cell, source base station, etc.) and a second network entity (e.g., target node, target cell, target base station, etc.). The WTRU may be configured to release the dual communication operation, for example, if a first condition is satisfied and/or if a release indication is received. Releasing the dual communication operation may include communicating with a single network entity (e.g., only with a single network entity). The single network entity may be the first network entity. The connection with the second network entity may be maintained (e.g., resources and/or configuration information are maintained). The WTRU may be configured to send an indication (e.g. to a network) that indicates that the dual communication operation is released.

The WTRU may receive configuration information indicating conditions associated with the dual communication operation. The configuration information may indicate release conditions associated with releasing and/or pausing the dual communication operations. The release conditions may be associated with one or more of the following: a time threshold, a radio quality, a load condition, a WTRU-specific condition, etc. The WTRU-specific condition may be associated with a buffer associated with the WTRU. The configuration information may indicate initiating conditions associated with initiating and/or resuming the dual communication operations. The initiating conditions may be associated with one or more of the following: a time threshold, a radio quality, a load condition, a WTRU-specific condition, etc. The WTRU may receive configuration information including an indication to perform the dual communication operation or an indication to release the dual communication operation.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of an example of a DAPS handover (HO).

FIG. 3A is a diagram illustrating an example of a user plane (UP) protocol architecture associated with integrated access and backhaul (IAB).

FIG. 3B is diagram illustrating an example of a control plane (CP) protocol architecture associated with IAB.

FIG. 4 is a diagram illustrating an example of inter-central unknit (CU) topology adaptation.

FIG. 5 illustrates an example of load-balancing using DAPS

FIG. 6 illustrates example signaling associated with a WTRU performing DAPS

FIG. 7 is a diagram illustrating example signaling associated with network-controlled starting and stopping of dynamic DAPS.

FIG. 8 is a diagram illustrating example signaling associated with network-controlled starting, pausing, and resuming of dynamic DAPS.

FIG. 9 is a diagram illustrating example signaling associated with starting, pausing, or resuming of dynamic DAPS based on conditions configured by a network.

### EXAMPLE NETWORKS FOR IMPLEMENTATION OF THE EMBODIMENTS

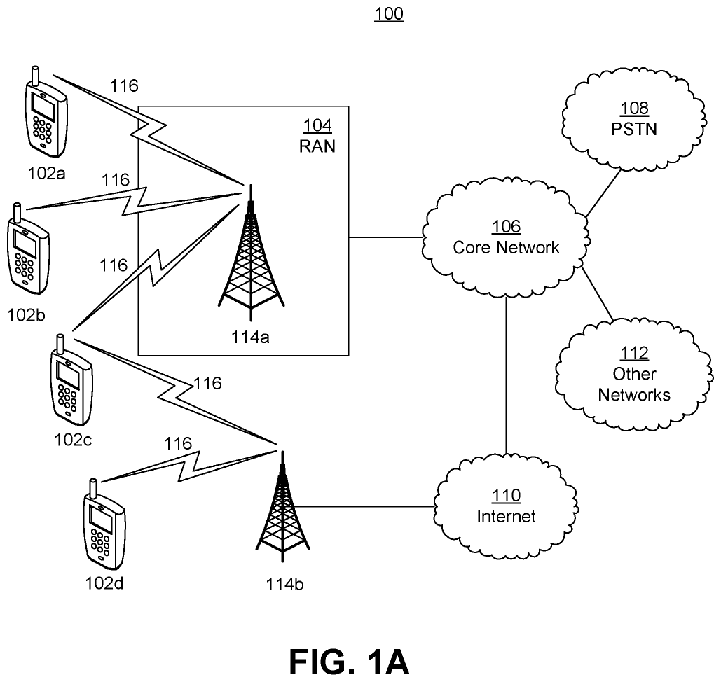

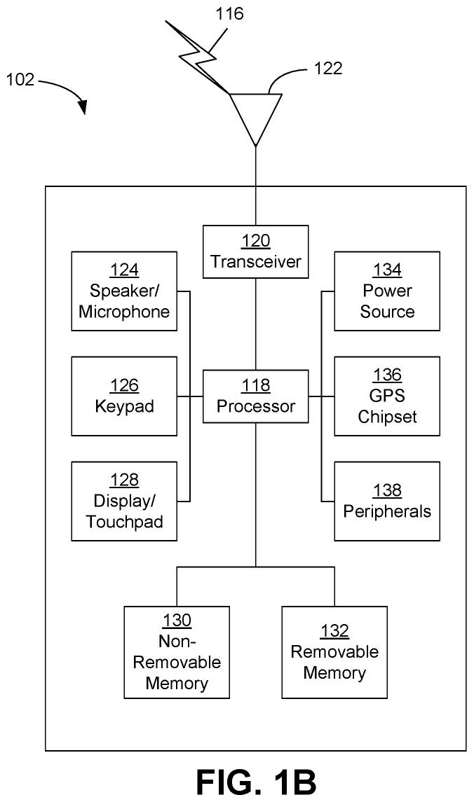

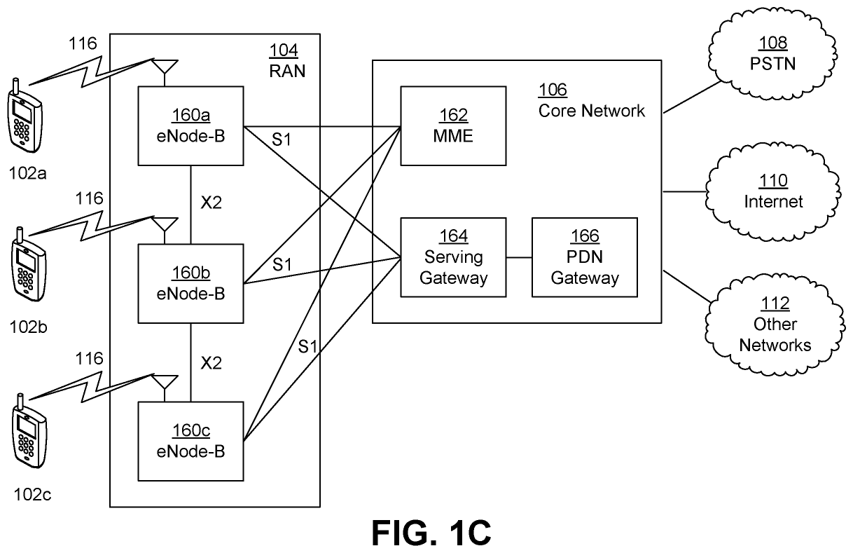

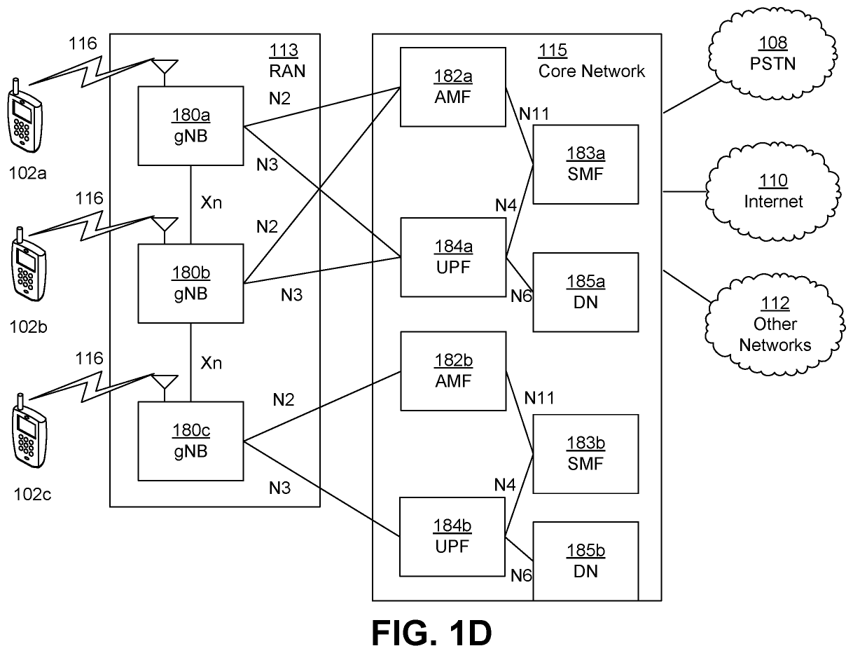

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein associated with dual active protocol stack (DAPS) operations (e.g., dual communication operations). DAPS operations may be performed to enable temporary load-balancing. Performing a handover (e.g., DAPS handover) may be expensive (e.g., in terms of resources) and less desirable for load-balancing purposes. Temporary DAPS operations may be performed to achieve temporary load-balancing without performing a handover. A wireless transmit/receive unit (WTRU) in communication with a first network entity may be configured to initiate dual communication operations (e.g., DAPS) towards a second network entity. The WTRU may maintain the dual communication between the first and second network entities, for example, until an indication to release the dual communication is received or until conditions are satisfied. Releasing the dual communication may prevent expensive handovers that may use excess resources.

To perform temporary-load balancing, a WTRU may be configured to perform the following. The WTRU may be configured to receive configuration information. The configuration information may include information associated with performance of a dual communication operation (e.g., DAPS). The WTRU may be configured to perform the dual communication operation based on the configuration information. The dual communication operation may include communicating with a first network entity (e.g., source node, source cell, source base station, etc.) and a second network entity (e.g., target node, target cell, target base station, etc.). The WTRU may be configured to release the dual communication operation, for example, if a first condition is satisfied and/or if a release indication is received. Releasing the dual communication operation may include communicating with a single network entity (e.g., only with a single network entity). The single network entity may be the first network entity. The connection with the second network entity may be maintained (e.g., resources and/or configuration information are maintained). The WTRU may be configured to send an indication (e.g. to a network) that indicates that the dual communication operation is released.

The WTRU may receive configuration information indicating conditions associated with the dual communication operation. The configuration information may indicate release conditions associated with releasing and/or pausing the dual communication operations. The release conditions may be associated with one or more of the following: a time threshold, a radio quality, a load condition, a WTRU-specific condition, etc. The WTRU-specific condition may be associated with a buffer associated with the WTRU. The configuration information may indicate initiating conditions associated with initiating and/or resuming the dual communication operations. The initiating conditions may be associated with one or more of the following: a time threshold, a radio quality, a load condition, a WTRU-specific condition, etc. The WTRU may receive configuration information including an indication to perform the dual communication operation or an indication to release the dual communication operation.

Described herein are systems, methods, and instrumentalities associated with dual protocol stack (DAPS) operations. A wireless transmit receive unit (WTRU) may be served by a serving network node or cell such as a source node or cell, and may be capable of (e.g., simultaneous with communicating with the source node or cell) communicating with another serving network node or cell such as a target node or cell. The WTRU may be configured to receive configuration information (e.g., DAPS configuration information) that instructs the WTRU to perform one or more DAPS operations (e.g., towards the target node). The configuration information may include one or more of the following: information about the target node or cell, an indication that that the DAPS configuration is separate from or unrelated to a handover (HO) configuration, timing information regarding when the DAPS configuration information is to be applied (e.g., a delta time period from the reception of the DAPS configuration information, a specific frame/slot number, etc.), timing information regarding for how long the DAPS configuration information is to be applied (e.g., is valid), one or more thresholds associated with radio conditions towards the source and/or target node (e.g., one or more reference signal received power (RSRP), reference signal received quality (RSRQ), received signal strength indicator (RSSI), signal to interference and noise ratio (SINR) thresholds), one or more thresholds associated with load conditions at the source and/or the target node, one or more thresholds associated with an uplink (UL) buffer status, UL buffer occupancy, and/or a type or quality of service (QoS) requirement of UL data, one or more thresholds associated with a downlink (DL) data rate and/or a type of DL data or QoS of DL data, or one or more thresholds associated with a delay or latency experienced by UL data (e.g., UL packets).

The WTRU may be configured to apply the DAPS configuration information, for example, by perform one or more DAPS operations according to the configuration information. The one or more DAPS operations may include start communicating (e.g., simultaneously) with the source node and the target node based on a determination that a first set of one or more conditions are fulfilled (e.g., a specified time to start DAPS has passed, one or more of the thresholds described herein for starting DAPS are fulfilled, etc.). The WTRU may be configured to release or pause the one or more DAPS operations and communicate with (e.g., only with) the source or the target node based on a determination that a second set of one or more conditions are fulfilled. For example, the WTRU may release or pause (e.g., suspend) the one or more DAPS operations based on a determination that a specified time duration for the DAPS operation has elapsed, that the conditions (e.g., one or more thresholds) for performing the one or more DAPS operations are no more fulfilled, or that a command (e.g., an explicit command) is received from the network (e.g., the source node or the target node) indicating that the DAPS operations are to be stopped or paused (e.g., suspended).

The WTRU may be configured to, e.g., while the one or more DAPS operation are suspended, keep monitoring the conditions for DAPS operations, keep UL synchronization with the target node, and/or resume the one or more DAPS operation based on a determination that the conditions (e.g., one or more thresholds) for starting the DAPS operations are fulfilled again or that a command (e.g., an explicit command) is received from the network (e.g., the source node or the target node) indicating that the one or more DAPS operations are to be resumed. The WTRU may send an indication to the network (e.g., the source node or the target node) if the WTRU releases, pauses (e.g., suspends), or resumes the one or more DAPS operations.

A dual action protocol stack (DAPS) handover may be performed. A DAPS handover may be performed, for example, to reduce a time (e.g., interruption time) during a handover. An interruption time during a handover may range from 30 ms to 60 ms (e.g., depending on the handover scenario). Reducing the interruption time during a handover may ensure that a quality of services (e.g., highly delay sensitive services) may not be degraded (e.g., because of mobility).

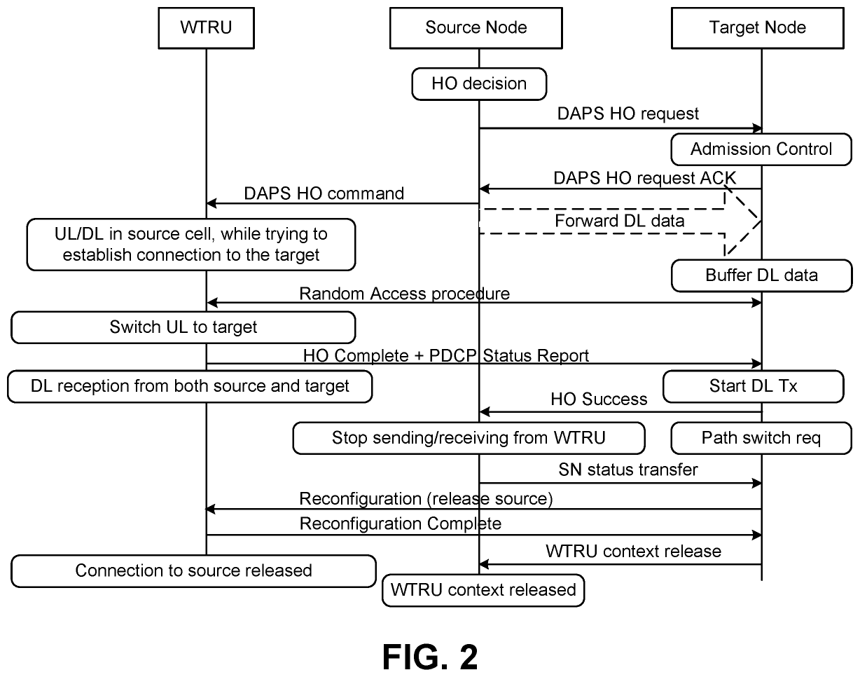

FIG. 2 illustrates an example of a DAPS handover (HO). As shown, a source node may (e.g., based on deciding to perform a DAPS HO) send a DAPS HO request to a target node. The DAPS HO request may be a handover request, for example, that includes information regarding to which data radio bearers (DRBs) the DAPS HO may be applied (e.g., it may be possible to apply normal HO for some DRBs). The target node may (e.g., after performing admission control) respond with a HO request acknowledgement.

The source may send a DAPS HO command to a WTRU (e.g., a UE). The DAPS HO command may include or be included in an RRC reconfiguration message (e.g., with reconfigurationWithSync set to true). The RRC reconfiguration message may include an indication regarding which DRBs may be involved in the DAPS HO. The source node may continue operation (e.g., normal operation) in the uplink (UL) (e.g., forwarding the data to a core network) and/or in the downlink (DL) (e.g., sending data to the WTRU). The source node may start forwarding the DL data towards the target node.

The WTRU may (e.g., based on completing a random access procedure with the target node) switch UL data transmission to the target node. The WTRU may continue (e.g., at least for a period of time after the random access) to perform DL reception from the source node. The WTRU may send a HO complete message (e.g., an RRC reconfiguration complete message) to the target node. The HO complete message may include, for example, a packet data convergence protocol (PDCP) status report for those DRBs configured for the DAPS HO. The target node may send (e.g., start to send) buffered DL data to the WTRU and may use status information (e.g., provided by the WTRU) to avoid sending duplicate packets (e.g., packets forwarded from the source node but now indicated to have been received by the WTRU) to the WTRU.

The target node may indicate to the source node that the handover has succeeded. The source node may stop sending and receiving data to/from the WTRU, for example, based on receiving an indication that the handover has succeeded. The target node may initiate a path switch, for example, towards the core network (e.g., so that new DL data may be sent to the target node instead of the source node). The target node may indicate to the WTRU that the DAPS HO is completed, for example, by sending a message (e.g., an RRC reconfiguration message) to the WTRU. The message may include an indication to release the source node (e.g., a daps-SourceRelease indicator). The WTRU may release the connection to the source node, for example, based on receiving an indication to release the source node. The target node may send a context release message to the source node, for example, so that the WTRU context at the source node may be released.

A DAPS handover may be configured at a DRB level (e.g., normal PDCP, radio link control (RLC) and/or media access control (MAC) procedures may be applied for radio bearers that are not configured for DAPS handover). A handover may be referred to as a DAPS handover, for example, if one (e.g., at least one) bearer is configured for DAPS. A handover (e.g., triggered by RRC signaling) may result in a WTRU resetting a MAC entity and re-establishing an RLC entity. For a DAPS handover, a WTRU may (e.g., based on reception of a handover command) perform one or more of the following. The WTRU may create a MAC entity for a target node. The WTRU may establish an RLC entity and/or an associated logical channel for a target node (e.g., for each DRB configured with DAPS). The WTRU may (e.g., for a DRB configured with DAPS) reconfigured a PDCP entity (e.g., with separate security and/or robust header compression (ROHC) functions) for a source node and/or a target node. The WTRU may associate the PDCP entity, the security functions, and/or the ROHC functions with one or more RLC entities associated with (e.g., configured by) the source node and/or the target node. The WTRU may retain one or more source configurations (e.g., those that have not been reset or re-established), for example, until being instructed to release the source node.

A mobile terminal (e.g., such as a WTRU) may receive user data from a source cell and a target cell (e.g., simultaneously from a source cell and a target cell). A WTRU (e.g., the PDCP layer of a WTRU) may be reconfigured to a common PDCP entity for the source and target user plane protocol stacks. PDCP Sequence Number (SN) continuation may be maintained during a handover procedure (e.g., to secure in-sequence delivery of user data). A common (e.g., same for source and target nodes) re-ordering and duplication function may be provided in a PDCP entity (e.g., a single PDCP entity such as the common PDCP entity described herein). Ciphering, deciphering, and/or header compression and decompression may be handled (e.g., handled separately) by a common (e.g., same) PDCP entity, for example, depending on the origin or destination of a DL/UL packet.

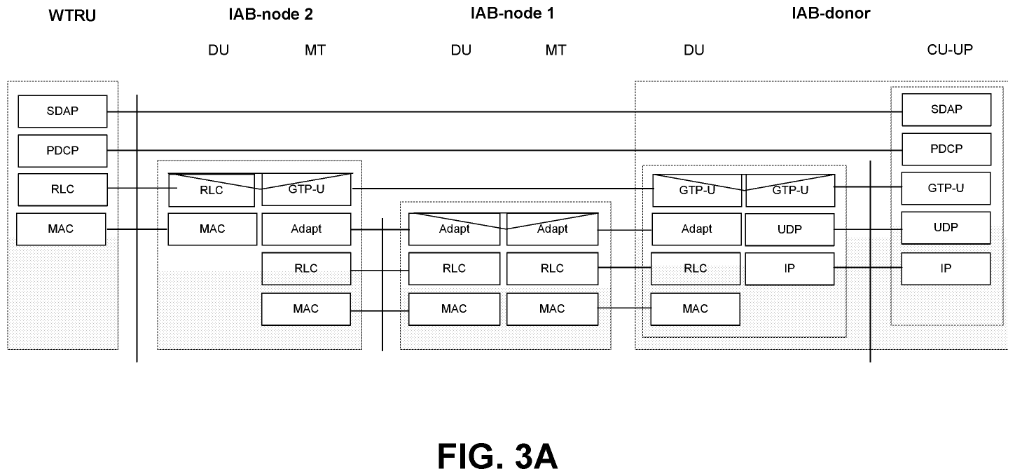

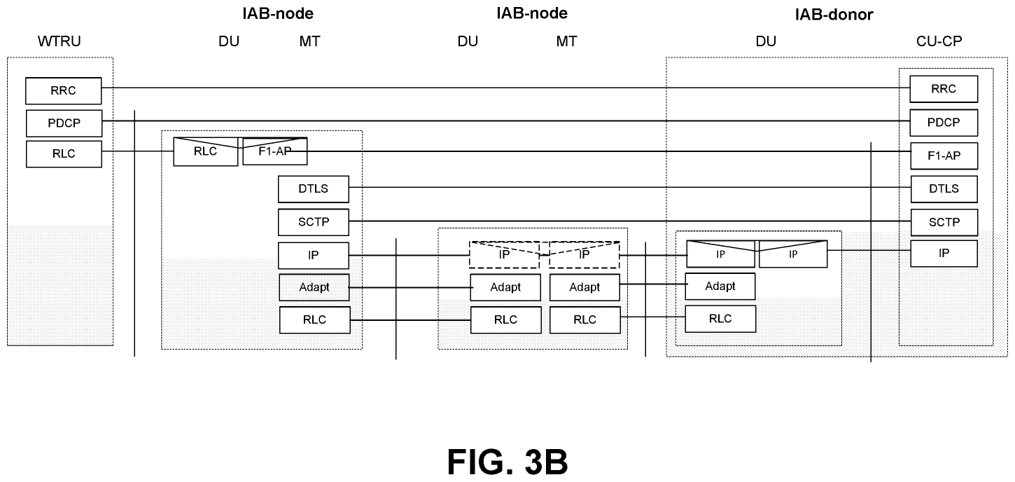

With integrated access and backhaul (IAB), part of a wireless spectrum may be used for the backhaul connection of base stations (e.g., instead of fiber connections). IAB may allow for more flexible and cheaper deployment of dense networks (e.g., as compared to deployments where there is a dedicated fiber link to the base stations). An IAB solution (e.g., full-fledged and/or multi-hop IAB solution) may be based on a split architecture (e.g., which may include a centralized unit (CU) and a distributed unit (DU)). FIG. 3A and FIG. 3B show an example of a user plane (UP) protocol architecture and an example of a control plane (CP) protocol architecture, respectively, for an IAB.

An IAB node's protocol stack may include multiple (e.g., two) sides or parts: a mobile termination (MT) part, which may be used to communicate with a parent node; and a DU part, which may be used to communicate with a child node or a WTRU (e.g., a normal WTRU). The UP and/or CP architectures may employ a routing/forwarding approach (e.g., inspired by IP networks), where an (e.g., each) IAB node may be assigned an IP address that may be routable from a donor base station and/or associated L2 addresses, and an intermediate IAB node may be configured to forward packets transparently based on route identifiers and/or destination addresses. A IAB node may terminate a DU functionality and a base station (e.g., which may be referred to as an IAB-donor) may terminate a CU functionality. An IAB node and a donor CU may (e.g., regardless of how many hops apart they are physically from each other) form a logical base station unit, for example, by employing a CU/DU split architecture. An IAB node serving a WTRU may be referred to as the access IAB node while the nodes between an IAB donor DU and the access IAB node may be referred to as intermediate IAB nodes. It should be noted that an IAB node may play the role of an access IAB node (e.g., for WTRUs that are directly connected to the IAB node) and/or an intermediate IAB node (e.g., for WTRUs that are served by descendant IAB nodes of the IAB node).

A hop-by-hop RLC may be used between IAB nodes, for example, instead of an End to End (E2E) RLC that may be deployed between a donor DU and a WTRU. Efficient multi-hop forwarding may be enabled, for example, by using an adaption layer (e.g., which may be referred to as a backhaul adaptation protocol (BAP)). An IAB-donor may assign a (e.g., unique) L2 address (e.g., a BAP address) to one or more IAB nodes (e.g., to each IAB node) controlled by the IAB donor. In examples (e.g., if/when there are multiple paths), multiple route IDs may be associated to a (e.g., each) BAP address. The BAP of an origin node (e.g., an IAB-donor DU for DL traffic, and/or an access IAB node for the UL) may add a BAP header to packets that are transmitted. Such a BAP header may include a BAP routing ID (e.g., a BAP address of the destination IAB node or source IAB node, and/or the path ID). If a packet arrives that has a BAP routing ID that includes a BAP address equal to an IAB node BAP address, the BAP may determine that the packet is destined for the BAP and may pass the packet on to higher layers for processing. Such a packet may be associated with, for example, an F1-C/U message destined for the IAB node's DU, an F1-C message that contains SRB data for a WTRU directly connected to the IAB node, or an F1-U message that contains DRB data for a WTRU directly connected to the IAB node. The IAB node may employ one or more routing or mapping tables to determine where to forward the data to, for example, if the BAP determines that the packet is not destined for the BAP. An IAB node (e.g., each IAB node) may have a routing table (e.g., configured by an IAB donor CU) that includes the next hop identifier for a (e.g., each) BAP routing ID. Separate routing tables may be maintained for DL and UL directions, where a DL table may be used by the DU part of an IAB node, while the MT part of the IAB node may use a UL table.

Backhaul (BH) RLC channels may be used for transporting packets between IAB nodes (or between an IAB-donor DU and an IAB node). BH RLC channel configuration information may include associated RLC and logical channel configuration information. A many-to-one (N:1) or a one-to-one (1:1) mapping may be performed, for example, between WTRU radio bearers and BH RLC channels. An N:1 mapping may multiplex (e.g., several) WTRU radio bearers into a (e.g. single) BH RLC channel, for example, based on (e.g., specific) parameters (e.g., such as a QoS profile of the bearers). Such a mapping may be suitable for bearers that may not have requirements (e.g., very strict requirements such as best effort bearers). A 1:1 mapping may map a (e.g., each) WTRU radio bearer onto a BH RLC channel (e.g., a separate BH RLC channel), and may be designed to ensure (e.g., finer) QoS granularity at the WTRU radio bearer level. A 1:1 mapping may be used (e.g., suitable) for bearers with throughput and/or latency considerations (e.g., strict throughput and/or latency requirements), such as guaranteed bit rate (GBR) bearers or VoIP bearers.

An IAB node may (e.g., if the IAB node detects a BH radio link failure (RLF)) send a BH RLF indication to its descendant nodes. The BH RLF indication may include or be included in a BAP control PDU. The IAB node may (e.g., based on receiving a BH RLF indication from a parent node) initiate operations (e.g., such as connection re-establishment operations) to a (e.g., another) parent node, or the IAB node may pause transmission/reception with the concerned parent node (e.g., parent node sending the BH RLF indication). The behavior of the IAB node on receiving BH RLF indication(s) may be determined based on (e.g., left to) IAB/network implementation.

In a multi-hop IAB network, data congestion may occur on an IAB node (e.g., intermediate IAB node), which may lead to packet drops (e.g., if left unresolved). Reliability may be ensured, for example, using protocols (e.g., higher layer protocols) such as TCP. TCP congestion avoidance and/or slow start mechanisms may be costly to the overall end-to-end performance (e.g., throughput degradation) of the network. An IAB network may employ flow control, for example, to improve end-to-end performance of the network. End-to-end (E2E) and/or hop-by-hop (H2H) flow control may be implemented, for example, for at least the DL.

DL E2E flow control may be based on a DL data delivery status (DDDS) which may be specified for CU/DU split architecture. In DDDS, a DU (e.g., in the context of IAB networks, the DU part of an access IAB node) may report to a CU (e.g., in the context of IAB networks, the donor CU, e.g., the CU-UP) information which may include the desired buffer size per DRB, a desired data rate per DRB, the highest successfully delivered PDCP SN, lost packets (e.g., packets not acknowledged by the DU at an RLC level), etc. In examples, access IAB nodes (e.g., only access IAB nodes) may report a DDDS (e.g., IABs may report only information concerning the DRBs of the WTRUs that they are directly serving) and/or information regarding BH RLC channels may be withheld (e.g., not be provided).

For DL H2H flow control, an IAB node may generate a flow control message (e.g., which may be a BAP control PDU), for example, if (e.g., when) the buffer load of the IAB node exceeds a threshold (e.g., certain level) or if (e.g., when) the IAB node receives a flow control polling message from a peer BAP entity (e.g., a child node). In examples, H2H flow control information may indicate an available buffer size, for example, at a granularity of BH RLC channels or destination routing IDs. For example, an available buffer size may be equal to value_1 for BH RLC channel #1, equal to value_2 for BH RLC channel #2, equal to value_1 if (e.g., when) a destination routing ID is address1, equal to value2 if (e.g., when) a destination routing ID is address2, etc. The node receiving the flow control message may use the information to control the traffic flow towards the sender. The node may throttle or pause the traffic associated with certain BH RLC channel(s) and/or destination(s), for example, if the flow control message indicates a low available buffer for the concerned traffic, the node may increase the traffic flow, for example, if the flow control indicates a high available buffer value, etc. In examples, the actions (e.g., exact actions) taken by a node regarding flow control, the configurations (or values of thresholds), and/or other parameters associated with triggering a flow control message (e.g., such as buffer threshold values, polling timers, etc.) may not be specified and may be left to IAB or network implementation.

Buffer status reporting (BSR) (e.g., pre-emptive BSR) may be specified (e.g., configured), for example, where an IAB node may trigger a BSR to its parent node(s) (e.g., before data (e.g., new data) has arrived in its UL buffer), which may be based on a BSR that the IAB node has received from its child node(s) or WTRU(s) or may be based on scheduling grants the IAB node has provided to the child node(s) or WTRU(s) (e.g., which may serve as an indication of anticipated data). Enhancements related to UL flow control may be applied where an IAB node may control the flow of UL data from its child node(s) and/or WTRUs by providing them with proper UL scheduling grants (e.g., based on a BSR received from the child node(s) or WTRU(s)). In examples, IAB nodes may be static nodes. Handover of IAB nodes (e.g., which may also be referred to as migration or relocation) from one donor to another may be supported for load balancing and/or for handling radio link failures (RLFs) due to blockage (e.g., due to moving objects such as vehicles, seasonal changes (e.g., foliage), infrastructure changes (e.g., new buildings), etc.). In examples, intra-donor CU handover (e.g., only intra-donor CU handover) may be supported (e.g., the target and the source parent DUs of the IAB node are controlled by the same donor CU). In examples, inter-donor CU handover may be supported.

IAB connectivity via multi-radio dual connectivity (MR-DC) may be supported. An IAB node may be connected to the network via E-UTRA NR Dual Connectivity (EN-DC), for example, where the master node may be an LTE node and the secondary node is an NR node.

IAB nodes may be transparent to WTRUs. For example, from the WTRU's point of view, IAB nodes may appear to be normal base stations.

IAB may be enhanced, for example, in one or more of the following aspects.

Topology adaptation may be enhanced. Procedures for inter-donor IAB-node migration may be provided to enhance robustness and load-balancing, which may include enhancements to reduce signaling load. Enhancements may be implemented to reduce service interruption due to IAB-node migration and/or BH RLF recovery. Enhancements may be implemented to introduce topological redundancy, including support of CP/UP separation.

Mobile IAB nodes may be supported, which may include the migrations of an IAB node from one parent node to another parent node (e.g., possibly involving a change of the donor DU or donor CU). Such mobility may facilitate load balancing and/or backhaul RLF handling. The migration of an IAB node may also be referred to as topology adaptation.

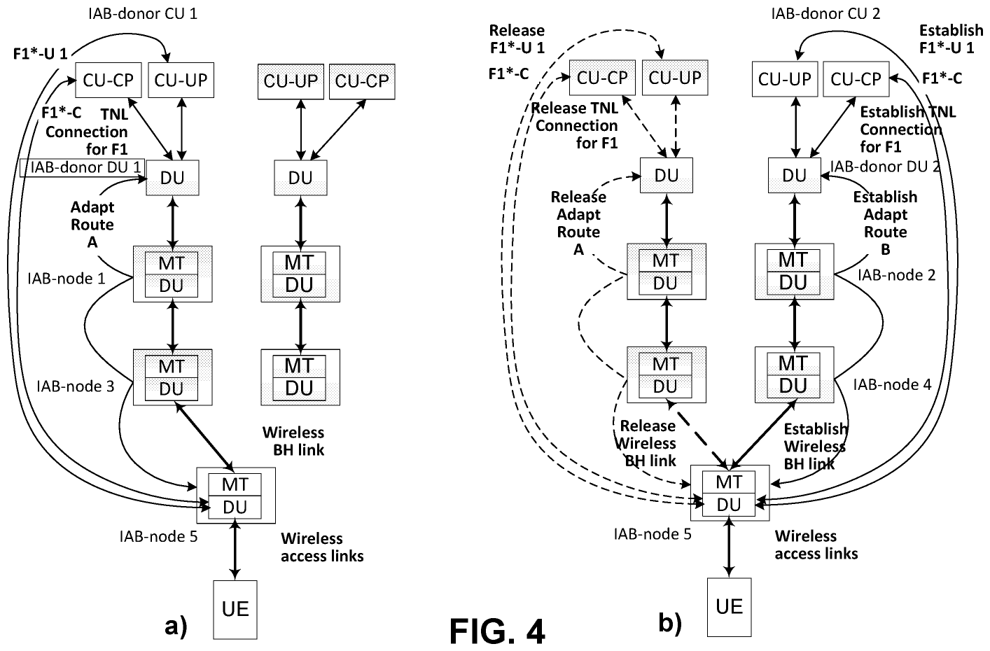

FIG. 4 illustrates an example of inter-CU topology adaptation. As shown, topology adaption may include one or more of the following: a route (e.g., new route) and/or resources (e.g., new resources) may be established via a another parent CU or path (e.g., a new parent CU or path). F1-U tunnels and/or F1-AP may be redirected to the route (e.g., new route). One or more previously used routes (e.g., old routes) or previously used resources (e.g., old resources) may be released.

As described herein, topology adaptation may involve relocating an IAB node from one parent to another parent node (e.g., possibly incurring a change of the donor CU). Such a relocation (e.g., in at least inter-CU relocation cases) may be an expensive procedure, e.g., from a signaling and/or resource perspective. This may be because the relocation may involve one or more of the following: inter-node communication/negotiation between the source and donor CUs for handling the handover as well as data forwarding between the two; admission and/or allocation of resources on one or more (e.g., all) hops of the new path (e.g., between a new parent node and a new donor DU); handover of one or more (e.g., all) direct and indirect descendant WTRUs of the migrating IAB node); relocation of one or more (e.g., all) direct and indirect descendant IAB nodes of the migrating IAB nodes to another (e.g., new) donor CU (e.g., which may involve the migration of one or more (e.g., all) F1-U/F1-C connections towards the (e.g., new) donor CU); etc.

For ease of description, a migrating IAB node may be shown herein as a leaf node (e.g., without child IAB node(s)). If the migrating IAB node is an intermediate node (e.g., a node having one or more child nodes) and is involved in inter-CU relocation, the costs associated with the relocation (e.g., from a signaling and/or resource perspective) may be exacerbated.

In examples, such as if (e.g., when) the migration of an IAB node is performed due to radio problems with the source parent (e.g., radio signal level or quality is insufficient to provide the required QoS for the BH RLC channels between the IAB node and its parent), one or more of the operations described herein may be undesirable. In examples, such as if (e.g., when) the migration of an IAB node is performed for load balancing purposes, relocating an IAB node and/or one or more (e.g., all) of its descendant WTRUs or nodes may cause unnecessary service interruption while the handover is ongoing.

DAPS HO may be used to mitigate service interruption during HO and/or for the IAB scenarios described herein. In examples (e.g., such as for the case of load balancing to mitigate temporary load or congestion), DAPS HO may not be necessary (e.g., as the HO may have one or more of the aforementioned issues associated with the migration of the IAB node via a standard HO, except for the service interruption aspect). If the load problem is temporary, a handover (e.g., DAPS HO or standard HO) may not help, for example, because soon after the HO, the IAB node may be migrated back again to the previous parent (e.g., if the radio conditions with the previous parent node remain stronger than with the current parent).

In examples, if (e.g., once) a WTRU is configured with HO (e.g., DAPS HO or normal HO), the HO may not be cancelled on the WTRU side (e.g., reverting the present HO may involve waiting until the present HO is completed and initiating a HO from the target back to the source). Thus, HO for temporary load balancing (e.g., in a multi-hop IAB network) may be resource and signaling intensive.

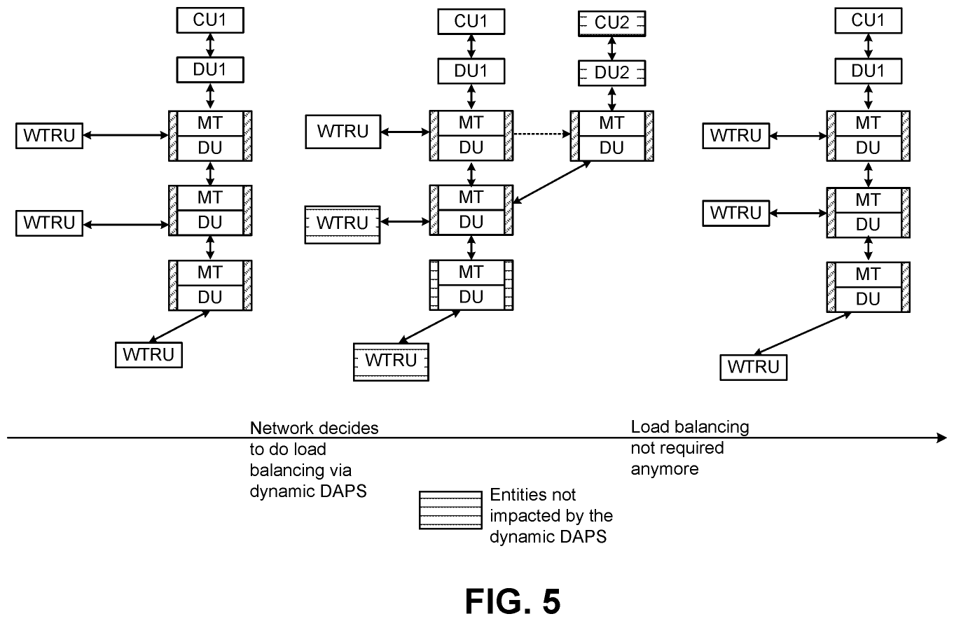

DAPS (e.g., a dual communication operation, such as where a device communicates with a first network entity and a second network entity) may be used to achieve load balancing, for example, if (e.g., when) IAB is configured or implemented. FIG. 5 illustrates an example of load-balancing using DAPS. The techniques described herein may be applicable to one or more types (e.g., any type) of wireless devices, including but not limited to, a WTRU, an IAB node (e.g., the MT part of an IAB node and/or the DU part of an IAB node), a sidelink WTRU acting as a WTRU-to-WTRU relay or WTRU-to-NW relay (e.g., over a sidelink), etc. When referred to herein, a WTRU may be said to be operating in a DAPS mode, for example, if (e.g., when) the WTRU is operating with a dual active protocol stack towards a source (e.g., first network entity) and a target node (e.g., second network entity), such as using an uplink/downlink towards both the source and target node (e.g., at the same time).

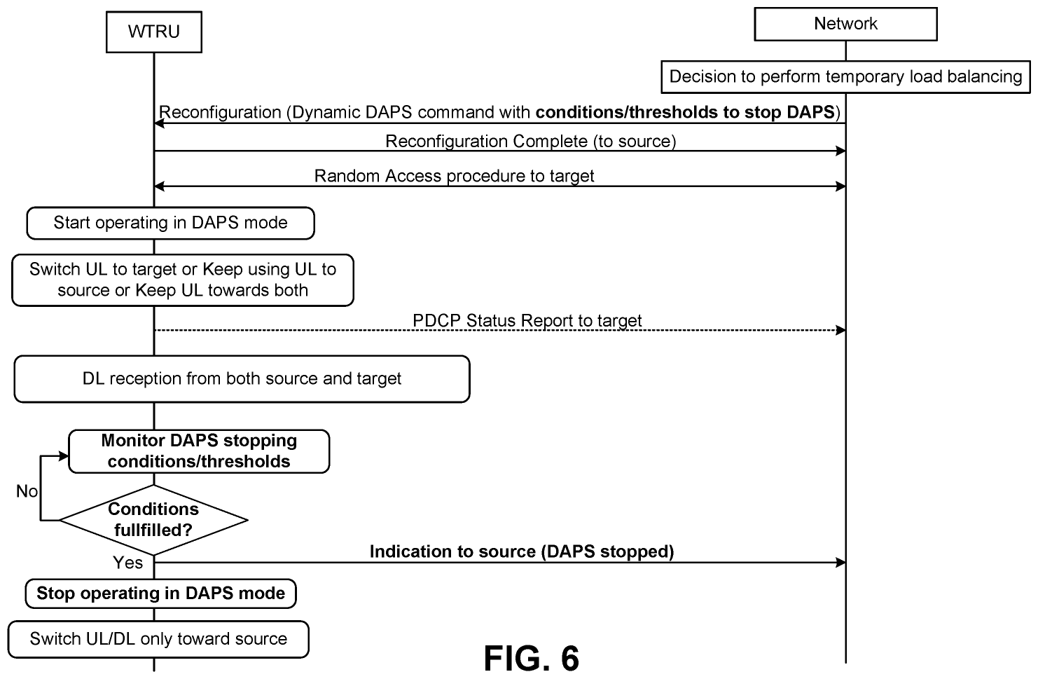

A WTRU (e.g., in communication with a source node (e.g., first network entity)) may be configured to setup, start, release, and/or resume a temporary dual protocol stack (e.g., dual communication) with the source node (e.g., first network entity) and a target node (e.g., a second network entity), for example as shown in FIG. 6. FIG. 6 illustrates example signaling associated with a WTRU performing DAPS. A WTRU may be provided with configuration information (e.g., a configuration message) to setup, start, release, and/or resume a temporary DAPS (e.g., temporary dual communication operation) with a source node (e.g., first network entity) and a target node (e.g., a second network entity). Such configuration information may be similar to DAPS HO configuration information and may include additional information indicating that the configuration is related to temporary DAPS (e.g., as shown in FIG. 6, the configuration information (e.g., reconfiguration) may include a DAPS command with conditions and/or thresholds to stop DAPS). In examples, the configuration information associated with the temporary DAPS may include, or be included in a RRC reconfiguration message that may include, radio bearer configuration information (e.g., comprising one or more bearers that have a DAPS configuration). In examples (e.g., in the case of an IAB node), the configuration information associated with the temporary DAPS may include, or be included in an RRC reconfiguration message that indicates, one or more BH RLC channels having a DAPS configuration.

A WTRU (e.g., in communication with a source node) may apply a DAPS configuration (e.g., dual communication configuration) and/or perform an (e.g., any) associated procedure such as a random access procedure towards a target node (e.g., as shown in FIG. 6). The WTRU may stay (e.g., start operating, as shown in FIG. 6) in a DAPS mode (e.g., dual communication with a first network entity and a second network entity, as shown in FIG. 6), for example, until subsequent configuration information from the network indicates that the DAPS configuration should be released. Such subsequent configuration information may include, or be included in an RRC reconfiguration message indicating, a DAPS release.

A WTRU may be configured to setup, start, release, and/or resume a temporary dual protocol stack with a source node and a target node for a duration (e.g., certain duration). In examples, a WTRU may be configured to setup, start, release, and/or resume a temporary DAPS with a source node and a target node for a certain duration. Configuration information (e.g., used to setup a temporary dual protocol stack) may be similar to DAPS HO configuration information and may include an additional information indicating the duration (e.g., a first time threshold) for which the DAPS configuration should be applied. The time duration (e.g., first time threshold) may include a specific time interval or duration from the reception or processing of a configuration message (e.g., in milliseconds or ms) or may include a specific frame or slot number. In examples (e.g., if a time interval is specified in the configuration information), the WTRU may start to track a time (e.g., via a timer) with a value equal to the configured time interval or duration. The WTRU may release the connection with a target node and may operate in a non-DAPS mode (e.g., using the source connection), for example, based on determining the time duration has expired (e.g., upon the expiry of the timer). In examples (e.g., if a specific frame or slot number is specified), the WTRU may revert to a non-DAPS mode at that specific frame/slot number.

In examples, the time duration described herein may be the same as the duration used when transmitting or receiving handover messages (e.g., the time duration may be substantially similar to the duration of an RRC timer such as t304, which may be provided to the WTRU via a reconfiguration message that contains a reconfiguration with sync). The WTRU may track (e.g., via counting or monitoring) the time duration, for example, based on a reception or application of DAPS configuration information, and the WTRU may perform one or more of the following: if a random access to a target node doesn't succeed before the time duration (e.g., timer) expires, legacy DAPS HO operation may continue (e.g., the WTRU may declare and/or report a DAPS HO failure, release the target configuration or connection, and/or resort the UL and/or DL to the source node (e.g., only to the source node); if the random access to the targe node succeeds, the WTRU may, e.g., instead of stopping the time period (e.g., stopping the timer such as t304), let the time period (e.g., the timer) continue to run, and may continue operating in the DAPS mode until the time period (e.g., the timer such as t304) expires.

In examples, the time duration described herein may be a time interval or duration from the completion (e.g., successful completion) of a random access (RA) to a target node. For example, a WTRU may start a first time duration (e.g., a first RRC timer such as t304), for example, as in a legacy HO, and may stop the first time duration (e.g., the timer) if an RA to a target node is successfully completed. The WTRU may (e.g., after stopping the first time duration or timer) start a second time duration (e.g., a second timer) with the time duration value specified in temporary DAPS configuration information. The second time duration may control how long the WTRU stays in the DAPS mode.

In examples, the time duration (e.g., as described herein, such as the duration from the reception of temporary DAPS configuration or the duration from a successful RA to a target node) may be specified separately from the DAPS configuration message. For example, the time duration may be provided in a previous reconfiguration message, for example, as part of initial time (e.g., via timers) and constants configuration information, in system information, etc.

A WTRU may be configured to setup, start, release, and/or resume a temporary dual protocol stack with a source node and a target node, for example, based on radio conditions (e.g., radio link conditions). In examples, a WTRU may be configured to setup, start, release, and/or resume a temporary DAPS with a source node and a target node based on the radio conditions towards a source node and/or the target node. Configuration information associated with setting up the temporary dual protocol stack may be similar to DAPS HO configuration information and may include additional information indicating thresholds related to a radio link towards the source node and/or the target node. The WTRU may be configured to operate in a DAPS mode, for example, as long as the thresholds (e.g., conditions) are met (e.g., fulfilled).

The additional information included in the configuration information associated with setting up, starting, releasing, and/or resuming the temporary dual protocol stack may include a condition related to the source's radio link conditions (e.g., RSRP/RSRQ/RSNI threshold(s)). The WTRU may operate in the DAPS mode, for example, while the condition is valid or satisfied. For example, if an RSRP threshold of x dBm is specified, the WTRU may initiate and/or operate (e.g., continue to operate) in the DAPS mode if the RSRP to the source is below x dBm. The WTRU may release the DAPS operation (e.g., revert to a non-DAPS operation), for example, if the RSRP with the source becomes greater than x dBm.

In examples, the additional information included in the configuration information associated with setting up the temporary dual protocol stack may include a condition related to the target's radio link conditions (e.g., RSRP/RSRQ/RSNI threshold(s)). The WTRU may operate in the DAPS mode while the condition is valid or satisfied. For example, if an RSRP threshold of y dBm is specified, the WTRU may initiate and/or operate (e.g., continue to operate) in the DAPS mode if the RSRP to the target is above y dBm. The WTRU may release the DAPS operation (e.g., revert to a non-DAPS operation) if the RSRP with the target drops below y dBm.

In examples, the additional information included in the configuration information associated with setting up the temporary dual protocol stack may include a condition related to the source's and the target's radio link conditions (e.g., RSRP/RSRQ/RSNI threshold(s)). The WTRU may operate in the DAPS mode while the condition is valid or satisfied. Examples of such a condition may include one or more thresholds (e.g., absolute thresholds) regarding the source and/or target radio links. For example, the thresholds may include an RSRP threshold (e.g., a first threshold) of x dBm towards the source code and an RSRP threshold (e.g., a second threshold) of y dBm towards the target code, which may be interpreted as providing that the WTRU may (e.g., is to) operate in the DAPS mode while the RSRP to the source is below x dBm and the RSRP to the target is above y dBm, or as providing that the WTRU may (e.g., is to) operate in the DAPS mode while the RSRP to the source is below x dBm or the RSRP to the target is above y dBm. Examples of such a condition may include relative thresholds regarding the source and/or target radio links. For example, a relative RSRP threshold of z dB may indicate to the WTRU that the WTRU may (e.g., is to) operate in the DAPS mode while the RSRP to the target is better than the RSRP to the source by z dBs.

In examples (e.g., when setting up a temporary dual protocol stack with a target node based on radio link conditions), a time to trigger (TTT) may be specified (e.g., via network configuration information). The TTT may indicate a duration, for example, for how long one or more conditions have to hold for a WTRU to consider the one or more conditions as being fulfilled. In examples (e.g., where an RSRP threshold with a source node is specified to be below and/or equal to (e.g., not more than) x dBm for maintaining the DAPS mode), a TTT of n ms may indicate that signals with the source have to be above xdBm for x ms before the WTRU reverts to a non-DAPS mode.

In examples (e.g., when setting up a temporary dual protocol stack with a target node based on radio link conditions), a hysteresis or offset value (e.g., threshold) may be specified (e.g., different thresholds may be used for entering and leaving a DAPS mode). For example, a WTRU may be configured to start DAPS operation if a signal towards the source node is below x dBm, and may be configured to stop the DAPS operation if a signal towards the source is above y dBm (e.g., where y may be a certain offset above x). This technique may be used in conjunction with the TTT described herein (e.g., a WTRU may release a DAPS operation (e.g., resort to a non-DAPS mode) if a signal is above ydBm for a duration equal to TTT).

A WTRU may be configured to setup, start, release, and/or resume a temporary dual protocol stack with source node and a target node based on network load conditions. A WTRU may be configured to setup, start, release, and/or resume a temporary DAPS with a source node and a target node, for example, based on one or more load conditions associated with a source node and/or the target node. Configuration information associated with setting up the temporary DAPS towards the target node may be similar to DAPS HO configuration information and may include additional information indicating thresholds related to the load conditions of the source and/or target. The WTRU may be configured to operate in the DAPS mode if the load thresholds are fulfilled or met. The WTRU may be provided with the current source and/or target load conditions, for example, via signaling, such as dedicated signaling or broadcast signaling (e.g., in system information such as a system information block). The WTRU may determine the load (e.g., current source and/or target load conditions) by itself (e.g., by determining the congestion level in the case of a sidelink connection or detecting collisions in the case of an unlicensed spectrum). The WTRU may request an update to the load conditions of the network, for example, on a need basis (e.g., by sending a load update request message to the network).

In examples, the additional information included in the configuration information associated with setting up the temporary DAPS may include a condition related to the source's load conditions. A WTRU may initiate and/or operate in the DAPS mode while the condition is valid or satisfied. For example, if a threshold of x % is specified, the WTRU may continue to operate in the DAPS mode while the load of the source node is above x %, and the WTRU may release the DAPS operation (e.g., revert to a non-DAPS operation) if the load of the source drops below x %.

In examples, the additional information included in the configuration information associated with setting up the temporary DAPS may include a condition related to the target's load link conditions. The WTRU may operate in the DAPS mode while the condition is still valid. For example, if a threshold of y % is specified, the WTRU may initiate and/or operate (e.g., continue to operate) in the DAPS mode while the load of the target node is below y %, and the WTRU may release the DAPS operation (e.g., revert to a non-DAPS operation) if the load of the target node drops below y %.

In examples, the additional information included in the configuration information associated with setting up the temporary DAPS may include a condition related to the source's and the target's load conditions. The WTRU may operate in the DAPS mode while the condition is valid or satisfied. A condition may include one or more thresholds (e.g., absolute thresholds) regarding the source and target loads. For example, the thresholds may include threshold x % concerning the source and y % concerning the target, which may be interpreted as indicating that the WTRU may (e.g., is to) operate in the DAPS mode while the load of the source is above x % and load of the target is below y %, or indicating that the WTRU may (e.g., is to) operate in the DAPS mode while the load of the source is above x % or load of the target is below y %.

The condition(s) described herein may include one or more thresholds (e.g., relative thresholds) regarding the source and target loads. For example, a relative load threshold of z % may indicate to the WTRU that it may (e.g., is to) operate in the DAPS mode while the load of the target is lower than the load of the source by z %.

In examples, the load-related trigger conditions (e.g., as described herein) may be based on flow control signaling from another node. For example, a WTRU may be the MT of an IAB node, and the source and target nodes may be two parent DUs of the IAB node. The WRU may determine to (e.g., decide to) operate in the DAPS mode or not, for example, based on the UL hop-by-hop signaling received (e.g., it is receiving) from the parent nodes. In examples, the WTRU may start the DAPS operation in response to (e.g., when) receiving a flow control message from the source that indicates UL congestion. In examples, the WTRU may stop or pause (e.g., release) the DAPS operation in response to (e.g., when) receiving a flow control message from the source (e.g., that indicates there is no more UL congestion). In examples, the WTRU may stop (e.g., release) the DAPS operation in response to (e.g., when) receiving a flow control message from the target (e.g., that indicates UL congestion). In examples, the WTRU may start or resume the DAPS operation in response to (e.g., when) receiving a flow control message from the target (e.g., that indicates there is no more UL congestion).

In examples based on load conditions (e.g., as described herein), a time to trigger (TTT) may be specified (e.g., in configuration information) that may indicate a duration, for example, for how long the condition has to hold for the WTRU to consider the condition as being fulfilled. For example, where (e.g., at least where) a load threshold with a source node is specified to be more than x % for maintaining the DAPS mode, a TTT of n ms may indicate that the load of the source is to be below x % for n ms before the WTRU may release DAPS (e.g., may revert to a non-DAPS mode).

In examples based on load conditions (e.g., as described herein), a hysteresis and/or offset value (e.g., threshold) may be specified (e.g., different thresholds may be used for initiating/entering and releasing/leaving a DAPS mode). For example, a WTRU may be configured to start a DAPS operation if (e.g., when) the load of the source is above x %, and may be configured to release (e.g., stop) the DAPS operation if (e.g., when) the load drops below y % (e.g., y may be a certain offset below x). This technique may be used in conjunction with the TTT (e.g., a WTRU may resort to a non-DAPS mode when the load is below y % for a duration equal to the TTT).

A WTRU may be configured to setup, start, release, and/or resume a temporary dual protocol stack with a source node and a target node based on conditions at the WTRU the WTRU may be configured to setup, start, release, and/or resume a temporary DAPS with a source node and a target node based on a buffer status (e.g., UL buffer status). Configuration information associated with setting up the temporary DAPS may be similar to DAPS HO configuration information and may include additional information indicating thresholds related to the buffer (e.g., UL buffer). The WTRU may be configured to operate in a DAPS mode, for example, if (e.g., as long as) the thresholds are fulfilled or met.

The additional information included in the configuration information associated with setting up the temporary DAPS may include a condition related to a current UL buffer size (e.g., a total UL buffer size) at the WTRU. The WTRU may operate in a DAPS mode while the condition is valid or satisfied. For example, if a threshold of x MB is specified, the WTRU may initiate and/or operate (e.g., continue to operate) in the DAPS mode if (e.g., while) its total UL buffer size is above x MB, and the WTRU may release the DAPS operation (e.g., revert to non-DAPS operation) if the buffer size drops below x MB.

The additional information included in the configuration information associated with setting up the temporary DAPS may include a condition related to the current percentage UL buffer occupancy at the WTRU. The WTRU may operate in the DAPS mode while the condition is valid or satisfied. For example, if a threshold of x % is specified, the WTRU may initiate and/or operate (e.g., continue to operate) in the DAPS mode if (e.g., while) its UL buffer occupancy is above x %, and the WTRU may release the DAPS operation (e.g., revert to non-DAPS operation) if the buffer occupancy drops below x %.

In examples, the additional information included in the configuration information associated with setting up the temporary DAPS may include a condition related to a current UL buffer size (e.g., the current total UL buffer size) at the WTRU for (e.g., certain) radio bearers and/or BH RLC channels. The UL buffer size may be indicated (e.g., explicitly) per DRB and/or BH RLC channel (e.g., based on a DRB ID, a logical channel ID (LCID), a BH RLC channel ID, etc.), or it may be indicated based on the QoS of a bearer (e.g., one or more GBR bearers, one or more URLLC bearers, one or more 1:1 mapped BH RLC channels, one or more N:1 mapped BH RLC channels, etc.). The WTRU may operate in a DAPS mode while the condition is valid or satisfied. For example, if a threshold of x MB is specified, the WTRU may initiate and/or operate (e.g., continue to operate) in the DAPS mode if (e.g., while) the UL buffer size of the indicated bearers or BH RLC channels is above x MB, and the WTRU may release the DAPS operation (e.g., revert to a non-DAPS operation) if the buffer size related to these bearers or BH RLC channels drops below x MB.

In examples, the additional information included in the configuration information associated with setting up the temporary DAPS may include a condition related to a current UL buffer occupancy (e.g., the current total UL buffer occupancy) at the WTRU for certain radio bearers and/or BH RLC channels. The UL buffer size may be indicated (e.g., explicitly) per DRB or BH RLC channel (e.g., based on a DRB ID, an LCID, a BH RLC channel ID, etc.), or it may be indicated based on the QoS of a bearer (e.g., one or more GBR bearers, one or more URLLC bearers, one or more 1:1 mapped BH RLC channels, one or more N:1 mapped BH RLC channels, etc.). The WTRU may operate in the DAPS mode while the condition is valid or satisfied. For example, if a threshold of x % is specified, the WTRU may initiate and/or operate (e.g., continue to operate) in the DAPS mode if (e.g., while) the UL buffer occupancy of the indicated bearers or BH RLC channels is above x %, and the WTRU may release the DAPS operation (e.g., revert to a non-DAPS operation) if the buffer occupancy related to these bearers or BH RLC channels drops below x %. Note that the % values here may refer to a percentage of the buffer size (e.g., maximum buffer size or a the current buffer size).

In examples, the additional information included in the configuration information associated with setting up the temporary DAPS may include a condition related to the current DL throughput at the WTRU. The WTRU may operate in the DAPS mode while the condition is valid or satisfied. For example, if a threshold of x Mbps is specified, the WTRU may initiate and/or operate (e.g., continue to operate) in the DAPS mode if (e.g., while) its current DL throughput is above x Mbps, and the WTRU may release the DAPS operation (e.g., revert to a non-DAPS operation) if the throughput drops below x Mbps. The WTRU may be provided with one or more additional parameters associated with calculating (e.g., on how to calculate) the throughput (e.g., the parameters may include a filtering and/or averaging window, whether to consider all bearers or BH RLC channels or a subset of bearers or BH RLC channels, etc.).

In examples, the additional information included in the configuration information associated with setting up the temporary DAPS may include a condition related to the latency experienced by UL packets. The WTRU may operate in the DAPS mode if (e.g., while) the condition is valid or satisfied. If a threshold of x ms is specified, the WTRU may initiate and/or operate (e.g., continue to operate) in the DAPS mode, for example, if (e.g., while) there are UL packets that have been waiting to be transmitted for more than x ms. The WTRU may be provided with one or more additional parameters on how to use this latency threshold (e.g., the parameters may include whether to consider all bearers or all BH RLC channels or a subset of bearers or BH RLC channels, whether to consider the condition fulfilled if there is a (e.g., one) packet that has been delayed by a specified amount or if a certain number or percentage of packets have been delayed by the specified amount, etc.).

In examples (e.g., based on buffer, throughput, and/or delay conditions at the WTRU), a time to trigger (TTT) may be specified (e.g., in the configuration information). The TTT may indicate a duration, such as, for how long a condition has to hold for the WTRU to consider the condition as being fulfilled. For example, where a total UL buffer occupancy is specified to be more than x MBs for maintaining the DAPS mode, a TTT of n ms may indicate that the buffer occupancy is to be below x MBs for n ms for (e.g., before) the WTRU releases the DAPS mode (e.g., reverts to a non-DAPS mode).

In examples (e.g., based on buffer, throughput, and/or delay conditions at the WTRU), a hysteresis or offset value (e.g., threshold) may be specified (e.g., different thresholds may be used for entering and leaving the DAPS mode). For example, a WTRU may be configured to start DAPS operation if the UL buffer occupancy is above x %, and configured to release (e.g., stop) the DAPS operation if (e.g., when) the occupancy drops below y % (e.g., where y may be a certain offset below x). This technique may be used in conjunction with the TTT (e.g., a WTRU may release the DAPS mode (e.g., resort to a non-DAPS mode) if (e.g., when) the buffer occupancy is below y % for a duration equal to TTT).

A WTRU may be configured to suspend (e.g., release, pause, etc.) or resume a temporary dual protocol stack with a target node (e.g., as shown in FIG. 6). In examples, the WTRU may be provided with configuration information (e.g., a configuration message) to suspend (e.g., release, pause, etc.) an already active DAPS towards a target node. Based on the reception of such configuration information, the WTRU may stop operating in (e.g., release, pause, suspend, etc.) the DAPS mode (e.g., the WTRU may have an UL or DL connection only with the source in such a case). The WTRU may refrain from releasing (e.g., not release) the target connection, but may suspend a (e.g., any) UL/DL transmission with the target node (e.g., the connection with the target node is maintained, such as the DAPS operation is paused). the WTRU may release the target connection, but may keep the DAPS configuration stored (e.g., the DAPS operation may be resumed). The WTRU may release the target connection and/or may delete the DAPS configuration.

In examples, the WTRU may be provided with configuration information (e.g., a configuration message) to resume an already suspended DAPS towards a target node. If the WTRU's connection to the target is released, the WTRU may apply the stored a DAPS configuration, perform an (e.g., any) associated procedures such as a random access procedure, and/or start operating in the DAPS mode. If the WTRU's connection to the target is not released but the UL and/or DL connections to the target are suspended, the WTRU may resume the UL and/or DL connections to the target.

In examples, if a WTRU is configured with condition(s) and/or thresholds for operating in the DAPS mode, in response to the conditions and/or thresholds being fulfilled, the WTRU may start, pause, or resume operating in the DAPS mode depending on the fulfillment of these conditions (e.g., as shown in FIG. 6). As described herein, the conditions may include source and/or target radio conditions, target and/or source load conditions, buffer conditions at the WTRU, throughput conditions at the WTRU, and/or delay conditions at the WTRU, etc. The WTRU may wait until the conditions are fulfilled (e.g., monitor the DAPS stopping conditions and/or thresholds, as shown in FIG. 6) to start operating in the DAPS mode, pause the DAPS operation if (e.g., when) the conditions are no longer fulfilled, and resume the DAPS operation if (e.g., when) the conditions are fulfilled again. The WTRU may send an indication to the network (e.g., a source node) if (e.g., when) the WTRU starts, pauses, or resumes the DAPS operation (e.g., as shown in FIG. 6).

In examples, if a WTRU pauses operating in the DAPS mode, the WTRU may keep UL in synchronization with a target node (e.g., the WTRU may keep running the timing advance timer (TAT), send UL reference signals, etc.). If UL synchronization is maintained (e.g., kept) by the time the DAPS operation is to be resumed again (e.g., in response to receiving a command to resume DAPS operation from the network, in response to one more conditions to operate in the DAPS mode being fulfilled, etc.), the WTRU may resume DAPS operation, for example, without performing random access to the target node.

In examples, if the UL synchronization with a target node is lost while DAPS operation is paused (e.g., when TAT expires), a WTRU may try to re-synchronize with the target (e.g., by sending UL reference signaling, performing RA procedure to get a TA update, etc.).

In examples, if a WTRU pauses operating in the DAPS mode, the WTRU may refrain from keeping (e.g., not keep) UL in synchronization with a target node and as such, may (e.g., always) perform RA to the target if (e.g., when) DAPS operation is resumed (e.g., later).

A WTRU may be configured with multiple temporary DAPS configurations. One or more (e.g., each) of the multiple temporary DAPS configurations may be associated with their own respective conditions (e.g., the conditions may concern different target nodes or target cells). Different configurations may be identified by respective DAPS configuration IDs, target cell IDs, target node IDs, etc. Different priorities may be assigned to the different configurations (e.g., the priorities may indicate which trigger conditions the WTRU is to check first). If no priorities are specified, WTRU implementation may determine (e.g., it may be left up to WTRU implementation to decide) which DAPS configuration's trigger conditions are to be checked first (e.g., first received configuration information may be checked first, last received configuration information may be checked first, a configuration may be selected randomly and its associated conditions may be checked first, etc.).

In examples, a WTRU may apply the DAPS configuration whose conditions are fulfilled and the WTRU may stop monitoring the conditions for the other DAPS configurations. If the conditions for a currently active DAPS configuration are not fulfilled anymore, the WTRU may start monitoring the conditions for the other configurations.

In examples, a WTRU may monitor the conditions for DAPS configurations that have a higher priority than a currently active DAPS configuration. If a higher priority configuration becomes fulfilled, the WTRU may release or stop the currently active DAPS configuration, and may start operating with the higher priority DAPS configuration (e.g., the WTRU may start operating in the DAPS mode with a target node associated with the higher priority DAPS configuration).

A WTRU may be configured to indicate to the network the status of one or more DAPS configurations or one or more DAPS modes. In examples, a WTRU may indicate to the network if (e.g., when) the conditions for starting a DAPS configuration get fulfilled. The WTRU may indicate to the network before the execution or application of the DAPS configuration (e.g., concerned DAPS configuration) or after the execution or application of the DAPS configuration (e.g., concerned DAPS configuration). If the WTRU is configured with multiple DAPS configurations, the WTRU may include an identification of the DAPS configuration (e.g., concerned DAPS configuration) in the indication sent to the network.

In examples, a WTRU may indicate to the network when the conditions for an active DAPS configuration are no longer fulfilled. The WTRU may indicate to the network before the WTRU leaves the DAPS mode and/or after the WTRU leaves the DAPS mode. If the WTRU is configured with multiple DAPS configurations, the WTRU may include an identification of the concerned DAPS configuration in the indication sent to the network.

A WTRU may be configured to handle transmission (e.g., UL transmission) in association with DAPS. In examples, if (e.g., when) a DAPS is established with a target node, a WTRU may switch the UL to the target node, e.g., after an RA with the target is completed successfully. In examples, if (e.g., when) a DAPS is established with a target node, a WTRU may, e.g., after an RA with the target is completed successfully, use the UL to the target for (e.g., only for) signaling (e.g., lower layer signaling, such as HARQ for DL transmissions), and/or the WTRU may keep UL transmission (e.g., higher layer UL transmission) with (e.g., only with) the source. In examples, when a DAPS is established with a target node, a WTRU may start the UL (e.g., for lower and/or higher layer transmissions) to the target node, for example, after an RA with the target is completed successfully. The WTRU may keep the UL with the source. The WTRU may be provided with further configuration information regarding which bearers or BH RLC channels are associated with the source and/or target node.

Different temporary DAPS trigger conditions may be combined. One or more of the techniques (e.g., as described herein) may be combined. For example, a WTRU may be configured (e.g., simultaneously) with conditions that are related to radio conditions, load conditions, and buffer/throughput/delay conditions at the WTRU. In examples, the WTRU may consider the conditions for DAPS fulfilled and start operating in the DAPS mode if all the conditions are fulfilled. In examples, the WTRU may consider the conditions for DAPS fulfilled and start operating in the DAPS mode if at least one of the conditions is fulfilled.

A WTRU may be configured with DAPS configuration operation that is associated with one or more of the following additional configuration information: start criteria, start time, evaluation interval, stop time, stop criteria, etc. Based on receiving such DAPS configuration information, the WTRU may perform one or more of the following. The WTRU may apply the DAPS configuration operation at the configured start time (e.g., which may be expressed as a timer or in relation to a subframe number). The WTRU may apply the DAPS configuration operation at a time (e.g., any time) after the configured start time, for example, if the configured start criteria is satisfied. The start criteria may be expressed in terms of one or more of a radio condition at the source and/or target node, a load condition at the source and/or target node, a WTRU UL buffer status, etc.

While operating in accordance with the DAPS configuration operation, the WTRU may be configured to evaluate the configured stop criteria, e.g., after the preconfigured evaluation interval. The stop criteria may be expressed in terms of one or more of a radio condition at the source and/or target node, a load condition at the source and/or target node, WTRU UL buffer status, etc. If an evaluation interval is not configured, the WTRU may monitor for the stop criteria (e.g., continuously) while operating in accordance with the DAPS configuration operation. If a stop criteria and/or stop timer is not configured, the WTRU may assume the DAPS configuration operation is valid (e.g., as long as the start criteria is satisfied).

The WTRU may be configured to release the DAPS operation when one or more of the following conditions are met, for example, whichever is earlier (e.g., if configured): the WTRU may release the DAPS operation if (e.g., when) the configured stop criteria is satisfied; the WTRU may release the DAPS operation after a preconfigured stop time (e.g., which may be expressed as a time elapsed from the configured start time or in relation to a subframe number).

Based on release of a first DAPS configuration operation, the WTRU may determine a second DAPS operation to apply based on the following: if the target connection is better than the source connection or better than a first threshold, the WTRU may release the source connection; else if the source connection is better than the target connection or a second threshold, the WTRU may release the target connection. The first and/or second thresholds may be expressed in terms of reference signal measurements, a measurement of data volume, and/or WTRU buffer status. The WTRU may be configured to indicate to a serving cell (e.g., source or target cell) the release of the DAPS operation.

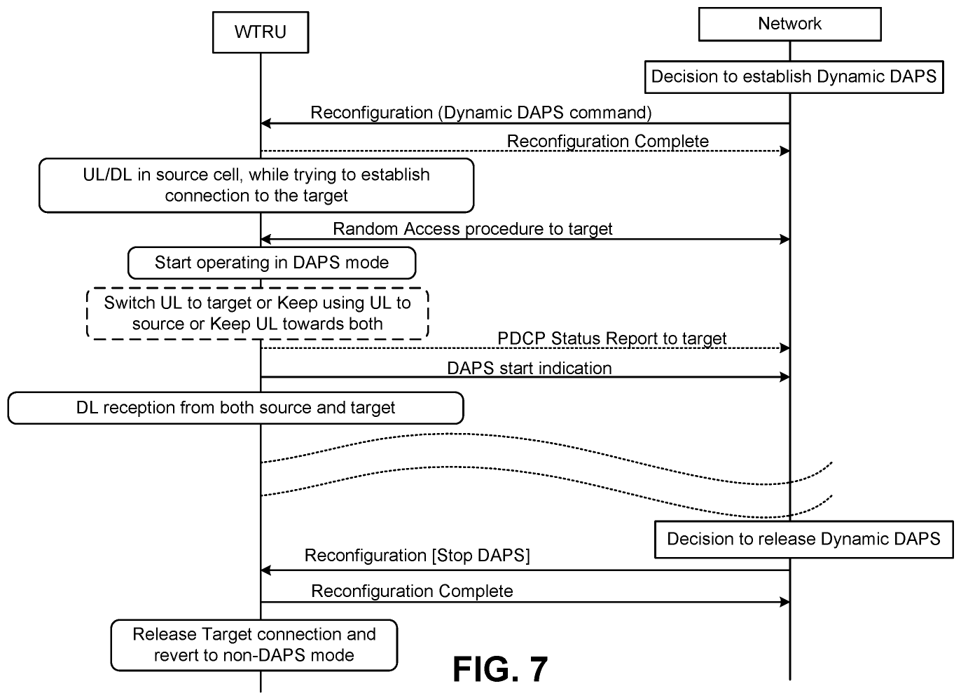

FIG. 7 shows example signaling associated with network controlled starting and stopping of dynamic DAPS (e.g., as described herein). As shown, a WTRU may receive a dynamic DAPS command or configuration information from the network and may respond with a complete message (e.g., which may indicate that the DAPS operation has been executed properly). The WTRU may establish (e.g., try to establish) a connection with a target node, e.g., by performing a random access procedure with the target node. On the success of the random access, the WTRU may start operating in a DAPS mode (e.g., with DL reception from the source and the target nodes). The WTRU may keep the UL connection with the source node, may switch the UL connection to the target node, or may keep the UL connection to both the source and target nodes. The WTRU may send a PDCP status report to the target node. The WTRU may indicate to the network e.g., the source node) that DAPS is up and running (e.g., the WTRU may defer the transmission of the reconfiguration complete message described above until this time and may include the indication in that message). The WTRU may (e.g., at a later point in time) receive a command or configuration information indicating to release the DAPS operation (e.g., stop operating in the DAPS mode), and may, in response, release the target connection and revert to a non-DAPS mode (e.g., the WTRU may keep UL and/or DL connection only with the source node). The WTRU may send a complete message to the network (e.g., the source node) indicating that DAPS has been released.

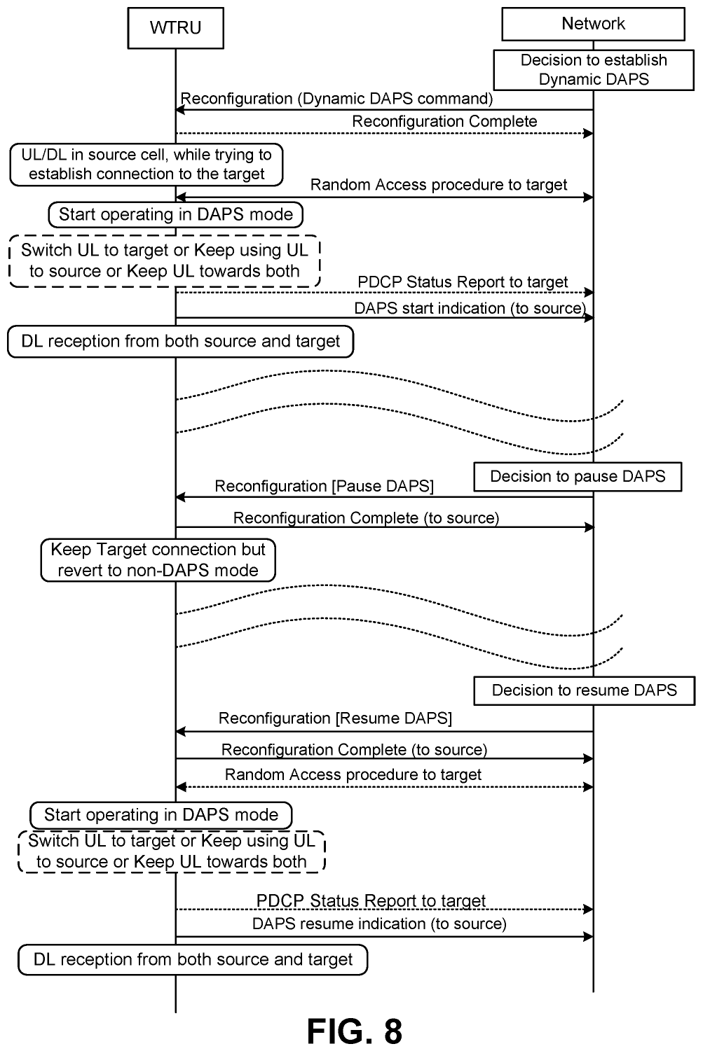

FIG. 8 shows example signaling associated with network-controlled starting, pausing, and resuming of dynamic DAPS as described herein. As shown, a WTRU may receive a dynamic DAPS command or configuration information from the network, and may respond with a complete message (e.g., which may indicate that the DAPS operation has been executed properly). The WTRU may establish (e.g., try to establish) a connection with a target node by performing a random access procedure. On the success of the random access, the WTRU may operate (e.g., start operating) in the DAPS mode, with DL reception from both the source and target nodes. The WTRU may keep the UL connection with the source node, may switch the UL connection to the target node, or may keep the UL connection to both the source and target nodes. The WTRU may send a PDCP status report to the target. The WTRU may indicate to the network (e.g., the source node) that DAPS is up and running (e.g., the WTRU may defer the transmission of the reconfiguration complete message described above until this time and may include the indication in that message). The WTRU may (e.g., at a later point in time) receive a command or configuration information to pause operating in the DAPS mode, and may, in response, keep the target connection, but may revert to a non-DAPS mode (e.g., the WTRU may keep UL and/or DL connection only with the source node). The WTRU may send a complete message to the network (e.g., the source node) indicating that DAPS has been paused.

The WTRU may (e.g., at a later point in time) receive a command or configuration information to resume operating in the DAPS mode. In response, the WTRU may perform a random access to the target node (e.g., only if UL sync has been lost). On the success of the random access or if the UL of the WTRU is still in synchronization with the target node, the WTRU may operate (e.g., start operating) in the DAPS mode (e.g., with DL reception from both the source and target nodes). The WTRU may keep the UL connection with the source node, may switch the UL connection to the target node, or may keep the UL connection to both the source and target nodes. The WTRU may send a PDCP status report to the target node. The WTRU may indicate to the network (e.g., the source node) that DAPS has been resumed (e.g., the WTRU may defer the transmission of the reconfiguration complete message after the reception of the resume DAPS message until this time and may include the indication in that message).

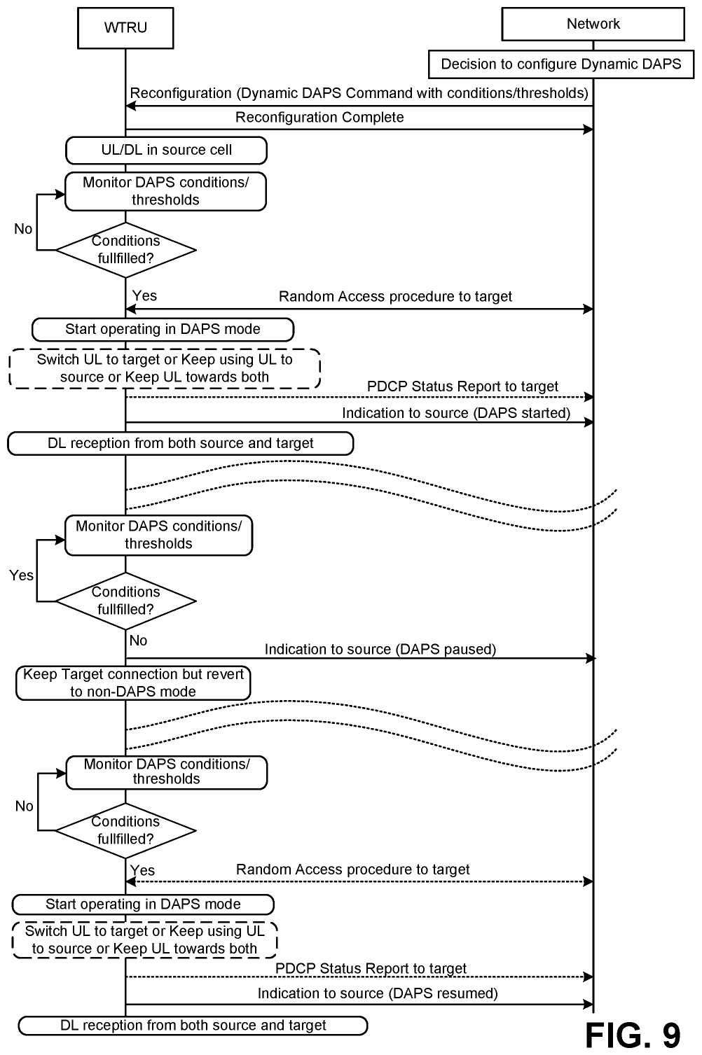

FIG. 9 shows example signaling associated with starting, pausing, or resuming of dynamic DAPS based on conditions or thresholds configured by the network as described herein. As shown, a WTRU may receive a dynamic DAPS command or configuration information from the network. The command or configuration information may include conditions and/or thresholds, for example, associated with operating in a DAPS mode, such as source and/or target radio thresholds, buffer thresholds, load thresholds, timers, etc. The WTRU may responds with a complete message (e.g., which may indicate that the DAPS operation has been executed properly). The WTRU may monitor the configured conditions (e.g., check if they are fulfilled). If a condition is fulfilled for operating in the DAPS mode, the WTRU may establish (e.g., try to establish) a connection with a target node, for example, by performing a random access procedure with the target. On the success of the random access, the WTRU may start operating in the DAPS mode (e.g., with DL reception from both the source and target nodes). The WTRU may keep the UL connection with the source, switch the UL connection to the target, or keep the UL connection to both the source and target nodes. The WTRU may send a PDCP status report to the target node. The WTRU may indicate to the network (e.g., the source node) that DAPS is up and running. The WTRU may keep monitoring the configured conditions, and may keep operating in the DAPS mode as long as the conditions are fulfilled. The WTRU may (e.g., at a later point in time) determine that the conditions are not fulfilled anymore. In response to the determination, the WTRU may keep the target connection, but may revert to a non-DAPS mode (e.g., the WTRU may keep UL and/or DL connection only with the source). The WTRU may send a message to the network (e.g. the source node) indicating that DAPS has been paused. The WTRU may (e.g., at a later point in time) determine that the conditions for operating in the DAPS mode are fulfilled once again, and may perform a random access to the target node (e.g., only if UL sync with the target has been lost). On the success of random access or if the UL of the WTRU is still in synchronization with the target, the WTRU may operate (e.g., start operating) in the DAPS mode, for example, with DL reception from both the source and target nodes. The WTRU may keep the UL connection with the source node, switch the UL connection to the target node, or keep the UL connection to both the source and target nodes. The WTRU may send a PDCP status report to the target node. The WTRU may indicate to the network (e.g., the source node) that DAPS has been resumed.

In one or more of the embodiments described herein, a wireless transmit receive unit (WTRU) may be served by a serving network node or cell such as a source node or cell, and may be capable of (e.g., simultaneous with communicating with the source node or cell) communicating with another serving network node or cell such as a target node or cell. The WTRU may be configured to receive configuration information (e.g., DAPS configuration information) that instructs the WTRU to perform one or more DAPS operations (e.g., towards the target node). The configuration information may include one or more of the following: information about the target node or cell, an indication that that the DAPS configuration is separate from or unrelated to a handover (HO) configuration, timing information regarding when the DAPS configuration information is to be applied (e.g., a delta time period from the reception of the DAPS configuration information, a specific frame/slot number, etc.), timing information regarding for how long the DAPS configuration information is to be applied (e.g., is valid), one or more thresholds associated with radio conditions towards the source and/or target node (e.g., one or more reference signal received power (RSRP), reference signal received quality (RSRQ), received signal strength indicator (RSSI), signal to interference and noise ratio (SINR) thresholds), one or more thresholds associated with load conditions at the source and/or the target node, one or more thresholds associated with an uplink (UL) buffer status, UL buffer occupancy, and/or a type or quality of service (QoS) requirement of UL data, one or more thresholds associated with a downlink (DL) data rate and/or a type of DL data or QoS of DL data, or one or more thresholds associated with a delay or latency experienced by UL data (e.g., UL packets).

The WTRU may be configured to apply the DAPS configuration information, for example, by performing one or more DAPS operations according to the configuration information. The one or more DAPS operations may include start communicating (e.g., simultaneously) with the source node and the target node based on a determination that a first set of one or more conditions are fulfilled (e.g., a specified time to start DAPS has passed, one or more of the thresholds described herein for starting DAPS are fulfilled, etc.). The WTRU may be configured to release or pause the one or more DAPS operations and communicate with (e.g., only with) the source or the target node based on a determination that a second set of one or more conditions are fulfilled. For example, the WTRU may release or pause (e.g., suspend) the one or more DAPS operations based on a determination that a specified time duration for the DAPS operation has elapsed, that the conditions (e.g., one or more thresholds) for performing the one or more DAPS operations are no more fulfilled, or that a command (e.g., an explicit command) is received from the network (e.g., the source node or the target node) indicating that the DAPS operations are to be stopped or paused (e.g., suspended).

The WTRU may be configured to, e.g., while the one or more DAPS operation are suspended, keep monitoring the conditions for DAPS operations, keep UL synchronization with the target node, and/or resume the one or more DAPS operation based on a determination that the conditions (e.g., one or more thresholds) for starting the DAPS operations are fulfilled again or that a command (e.g., an explicit command) is received from the network (e.g., the source node or the target node) indicating that the one or more DAPS operations are to be resumed. The WTRU may send an indication to the network (e.g., the source node or the target node) if the WTRU releases, pauses (e.g., suspends), or resumes the one or more DAPS operations.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A wireless transmit/receive unit (WTRU) comprising:
a processor configured to:
perform a single communication operation with a first network entity;
receive configuration information, wherein the configuration information comprises information associated with a performance of a dual communication operation, and wherein the configuration information indicates a bearer associated with the dual communication operation and a data threshold associated with the bearer;
perform a first dual communication operation based on a first amount of data associated with the bearer being above the data threshold, wherein the first dual communication operation comprises communicating with the first network entity and a second network entity;
release the first dual communication operation based on a second amount of data associated with the bearer being below the data threshold, wherein releasing the first dual communication operation comprises communicating with a single network entity, and wherein the single network entity is the first network entity;
send an indication, wherein the indication indicates that the dual communication operation is released; and
based on a third amount of data associated with the bearer being above the data threshold, perform a second dual communication operation, wherein the second dual communication operation comprises communicating with the first network entity and a third network entity.

20. The WTRU of claim 19, wherein the first network entity is a first cell or a first base station, and wherein the second network entity is a second cell or a second base station.

21. The WTRU of claim 19, wherein the release of the first dual communication operation is further based on if a release condition associated with releasing dual communication operation is satisfied or if a release indication has been received, wherein the release condition is associated with one or more of a time threshold, a radio quality, a load condition, or a WTRU-specific condition, and wherein the WTRU-specific condition is associated with a buffer associated with the WTRU.

22. The WTRU of claim 21, wherein the configuration information further comprises the release condition associated with releasing dual communication operation.

23. The WTRU of claim 19, wherein the third network entity is the second network entity.

24. The WTRU of claim 19, wherein the performed second dual communication operation is further based on if an initiation condition associated with performing dual communication operation is satisfied or if a resume indication has been received, and wherein the configuration information further comprises the initiation condition associated with performing dual communication operation.

25. The WTRU of claim 24, wherein the initiation condition is associated with one or more of a time threshold, a radio quality, a load condition, or a WTRU-specific condition, wherein the WTRU-specific condition is associated with a buffer associated with the WTRU.

26. The WTRU of claim 19, wherein the configuration information comprises an indication to perform the dual communication operation.

27. The WTRU of claim 19, wherein the dual communication operation is associated with a dual active protocol stack.

28. A method comprising:
performing a single communication operation with a first network entity;
receiving configuration information, wherein the configuration information comprises information associated with a performance of a dual communication operation, and wherein the configuration information indicates a bearer associated with the dual communication operation and a data threshold associated with the bearer;
performing a first dual communication operation based on a first amount of data associated with the bearer being above the data threshold, wherein the first dual communication operation comprises communicating with the first network entity and a second network entity;
releasing the first dual communication operation based on a second amount of data associated with the bearer being below the data threshold, wherein releasing the first dual communication operation comprises communicating with a single network entity, and wherein the single network entity is the first network entity;
sending an indication, wherein the indication indicates that the dual communication operation is released; and
based on a third amount of data associated with the bearer being above the data threshold, performing a second dual communication operation, wherein the second dual communication operation comprises communicating with the first network entity and a third network entity.

29. The method of claim 28, wherein the first network entity is a first cell or a first base station, and wherein the second network entity is a second cell or a second base station.

30. The method of claim 28, wherein the release of the first dual communication operation is further based on if a release condition associated with releasing dual communication operation is satisfied or if a release indication has been received, wherein the release condition is associated with one or more of a time threshold, a radio quality, a load condition, or a WTRU-specific condition, and wherein the WTRU-specific condition is associated with a buffer associated with a WTRU.

31. The method of claim 30, wherein the configuration information further comprises the release condition associated with releasing dual communication operation.

32. The method of claim 28, wherein the third network entity is the second network entity.

33. The method of claim 28, wherein the performed second dual communication operation is further based on if an initiation condition associated with performing dual communication operation is satisfied or if a resume indication has been received, and wherein the configuration information further comprises the initiation condition associated with performing dual communication operation.

34. The method of claim 33, wherein the initiation condition is associated with one or more of a time threshold, a radio quality, a load condition, or a WTRU-specific condition, wherein the WTRU-specific condition is associated with a buffer associated with a WTRU.

35. The method of claim 28, wherein the configuration information comprises an indication to perform the dual communication operation.

36. The method of claim 28, wherein the dual communication operation is associated with a dual active protocol stack.
